(19) United States
(12) Patent Application Publication
(10) Pub. No.: US 2012/0154457 A1
(43) Pub. Date: Jun. 21, 2012

(54) DISPLAY PANEL AND DISPLAY DEVICE

(75) Inventors: Kazunari Katsumoto, Osaka-shi (JP); Kaori Saitoh, Osaka-shi (JP)

(73) Assignee: Sharp Kabushiki Kaisha, Osaka-shi, Osaka (JP)

(21) Appl. No.: 13/392,822

(22) PCT Filed: May 24, 2010
(86) PCT No.: PCT/JP2010/058767

§ 371 Date: Feb. 27, 2012

(30) Foreign Application Priority Data
Sep. 2, 2009 (JP) 2009-202983

(51) Int. Cl. G09G 3/36; G09G 5/10

(52) U.S. Cl. 345/690; 345/88

(57) ABSTRACT

A voltage is applied to liquid crystal which corresponds to each pixel so that the voltage is supplied to a source of a TFT (30) and is outputted from a drain of the TFT (30), a voltage at which light transmittance becomes a maximum value in the each pixel varying depending on the color displayed by the each pixel, source-drain capacitance being set to be larger in a pixel for displaying a corresponding color, in which pixel a voltage at which light transmittance becomes a maximum value is lower. This allows an effective voltage, applied to liquid crystal corresponding to each pixel during the voltage application, to vary depending on the color of the each pixel. This allows a voltage, at which transmittance in each of the pixels of the respective colors becomes a maximum value, to be applied to the liquid crystals corresponding to the pixels. This makes it possible to (i) prevent gradation deviation in the pixels of the respective colors and (ii) improve overall transmittance of white light in the pixels included in the display panel (2).

This application is the national stage under 35 USC 371 of International Application No. PCT/JP2010/058767, filed May 24, 2010, which claims priority from Japanese Patent Application No. 2009-202983, filed Sep. 2, 2009, the entire contents of which are incorporated herein by reference.

### FIELD OF THE INVENTION

The present invention relates to a display panel for color display of an image and a display device for color display of an image.

### BACKGROUND OF THE INVENTION

FIG. 7 is a graph showing how light transmittance 132 is changed in response to a voltage 131 applied to liquid crystal in a conventional liquid crystal display device. The graph shows light transmittance 133 (hereinafter referred to as transmittance 133) of a pixel (hereinafter referred to as a pixel R) corresponding to a red color filter, light transmittance 134 (hereinafter referred to as transmittance 134) of a pixel (hereinafter referred to as a pixel G) corresponding to a green color filter, and light transmittance 135 (hereinafter referred to as transmittance 135) of a pixel (hereinafter referred to as a pixel B) corresponding to a blue color filter.

The double-pointed arrow 139 directly below the graph in FIG. 7 indicates a range within which an effective voltage to be applied to liquid crystal is set in a driver IC in which RGB independent γ-setting is not carried out. In the RGB independent γ-setting, a γ characteristic is set separately for each of the pixels R, G, and B.

The three double-pointed arrows indicated below the double-pointed arrow 139 are, from top, (i) a voltage 140 applied to liquid crystal corresponding to the pixel B (hereinafter referred to as a voltage 140); (ii) a voltage 141 applied to liquid crystal corresponding to the pixel G (hereinafter referred to as a voltage 141), and (ii) a voltage 142 applied to liquid crystal corresponding to the pixel R (hereinafter referred to as a voltage 142). Note that the voltage 140 is a voltage at which the transmittance 135 becomes a maximum value, and is lower than the voltage 141. The voltage 141 is a voltage at which the transmittance 134 becomes a maximum value, and is lower than the voltage 142. The voltage 142 is a voltage at which the transmittance 133 becomes a maximum value.

A sum of the transmittances 133, 134, and 135 (transmittance 138 of an achromatic color, which ranges from black to white) obtained in a case where a same voltage is applied to liquid crystals corresponding to the respective pixels R, G, and B is indicated by the bold broken line. The arrow 137 indicates that the transmittance 135 is increased in a case where an applied voltage is changed from the voltage 141 to the voltage 140.

As is shown by the transmittances 133, 134, and 135, a voltage at which light transmittance becomes a maximum value varies from color to color. For example, the transmittance 134 becomes a maximum value at the voltage 141. Such being the case, the voltage 141 can be used as a maximum voltage for displaying white. However, at the voltage 141, only the pixel G exhibits its maximum transmittance. The transmittances exhibited by the respective pixels R and B at the voltage 141 are lower than their maximum transmittances. In particular, the transmittance 135 at the voltage 141 has even dropped from its peak. This causes gradation deviation in the pixel B.

Several techniques have been disclosed as methods for improving the transmittances of the liquid crystals for the respective colors in the conventional liquid crystal display device.

Patent Literature 1 discloses a technique for preventing gradation deviation. In the technique, (i) a drive circuit (hereinafter referred to as a driver IC), which corrects voltages to be applied to liquid crystals corresponding to respective colors R, G, and B of color filters, is manufactured and (ii) a display is driven by means of the drive circuit.

Patent Literature 2 discloses a technique of providing a charge storage capacitor (storage capacitor) between a pixel electrode and scanning signal wiring (gate wiring) in a liquid crystal device employing a liquid crystal display element of a transverse electric field type.

Patent Literature 1

Japanese Patent Application Publication, Tokukai, No. 2001-134242 A (Publication Date: May 18, 2001)

Patent Literature 2

Japanese Patent Application Publication, Tokukai, No. 2003-241213 A (Publication Date: Aug. 27, 2003)

### SUMMARY OF THE INVENTION

The technique disclosed in Patent Literature 1 enables optimum gamma correction that is well suited to characteristics of a color liquid crystal display. In addition, even in a case where gradation deviation occurs in one of the colors R, G, and B, the technique allows elimination of the gradation deviation in the color.

However, the technique disclosed in Patent Literature 1 causes an increase in load and cost of the setting of the driver IC. In addition, the driver IC loses versatility and therefore cannot be applied to a panel having a different pixel arrangement.

The technique of Patent Literature 2 is a technique for improving optical characteristics without the need of setting the driver IC. In the technique, different values are set to storage capacitors Cs of the respective pixels R, G, and B, so that an instantaneous voltage increase is controlled. This makes it possible to set a y-characteristic separately for each of the colors R, G, and B.

However, since the storage capacitor Cs is changed from color to color in the technique disclosed in Patent Literature 2, a charge retention characteristic varies from color to color. This may lead to an occurrence of display unevenness or flickers, and the like.

The present invention is accomplished in view of the aforementioned problem. An object of the present invention is to provide a display panel and a display device, both of which can attain an improvement in overcoming gradation deterioration while maintaining versatility, without the need of a dedicated driver IC for correcting a voltage applied to liquid crystal corresponding to each of pixels of different colors.

In order to attain the object, a display panel of the present invention is a display panel including: a plurality of pixels each (i) displaying a corresponding one of a plurality of colors and (ii) including a switching element, a voltage being applied to liquid crystal which corresponds to each of the plurality of pixels so that the voltage is supplied to a source of the switching element and is outputted from a drain of the switching element, a voltage at which light transmittance becomes a maximum value in the each of the plurality of pixels varying depending on the color displayed by the each of the plurality of pixels, source-drain capacitance between the source and the drain being set to be larger in a pixel for displaying a corresponding color, in which pixel a voltage at which light transmittance becomes a maximum value is lower.

According to the invention, the display panel includes the plurality of pixels. The plurality of pixels display respective different colors. The respective different colors are, for example, color additive primaries. In the display panel, capacitance (source-drain capacitance) generated between the source of the switching element and the drain of the switching element in the each of the plurality of pixels varies depending on the color displayed by the each of the plurality of pixels. Accordingly, in a display panel in which a voltage at which light transmittance becomes a maximum value in each of a plurality of pixels varies depending on the color displayed by the each of the plurality of pixels, it becomes possible to change an effective voltage, applied to liquid crystal corresponding to the each of the plurality of pixels during the voltage application, depending on the color.

Specifically, since the source-drain capacitance is set to be larger in a pixel for displaying a corresponding color, in which pixel a voltage at which light transmittance becomes a maximum value is lower, it is possible to increase a feed-through voltage to which an electric potential of the pixel is subjected due to the source-drain capacitance. As a result, the effective voltage for the pixel can be lowered.

This makes it possible to apply a voltage, at which light transmittance in a pixel for displaying a corresponding color, becomes a maximum value, to liquid crystal corresponding to the pixel, even in a case where the voltage at which the light transmittance in the pixel becomes a maximum voltage is low. Accordingly, it becomes possible to (i) prevent gradation deviation in the plurality of pixels of the respective colors and (ii) improve transmittance of the overall pixels (the pixels of the respective colors included in the display panel), in other words, transmittance of white light. This can be realized without the need of a dedicated driver IC for correcting the voltage applied to the liquid crystal corresponding to each of the pixels of the respective colors.

In order to attain the object, a display panel of the present invention is a display panel including a plurality of pixels each including a corresponding different color filter and a switching element, source-drain capacitance between a source and a drain of the switching element in each of the plurality of pixels being set so as to vary in accordance with a color displayed by the each of the plurality of pixels, source-drain capacitance in a pixel for displaying a blue color being larger than source-drain capacitance in a pixel for displaying a green color, and the source-drain capacitance in the pixel for displaying the green color being larger than source-drain capacitance in a pixel for displaying a red color.

According to the invention, the display panel includes the plurality of pixels. The plurality of pixels include different color filters and therefore display respective different colors. Examples of the respective different colors encompass red, green, and blue, which are color additive primaries.

In a plurality of pixels each including a red color filter, a green color filter, or a green color filter, a relation between (a) a voltage applied to each of the plurality of pixels via a corresponding switching element and (b) light transmittance of the each of the plurality of pixels is usually such that (i) a voltage at which light transmittance of the pixel including the red color filter becomes a maximum value is higher than a voltage at which light transmittance of the pixel including the green color filter becomes a maximum value and (ii) the voltage at which the light transmittance of the pixel including the green color filter becomes a maximum value is higher than a voltage at which light transmittance of the pixel including the blue color filter.

Because of this, the source-drain capacitance is set to be larger in a pixel for displaying a corresponding color, in which pixel a voltage at which light transmittance becomes a maximum value is lower. This allows the effective voltage for the pixel to be reduced. Consequently, it becomes possible to attain an effect substantially equal to the aforementioned effect.

As described above, in a display panel of the present invention, a voltage is applied to liquid crystal which corresponds to each of a plurality of pixels so that the voltage is supplied to a source of a corresponding switching element and is outputted from a drain of the switching element, a voltage at which light transmittance becomes a maximum value in the each of the plurality of pixels varying depending on the color displayed by the each of the plurality of pixels, source-drain capacitance between the source and the drain being set to be larger in a pixel for displaying a corresponding color, in which pixel a voltage at which light transmittance becomes a maximum value is lower.

As described above, in a display panel of the present invention, source-drain capacitance between a source and a drain of a switching element in each of a plurality of pixels is set so as to vary in accordance with a color displayed by the each of the plurality of pixels, source-drain capacitance in a pixel for displaying a blue color being larger than source-drain capacitance in a pixel for displaying a green color, and the source-drain capacitance in the pixel for displaying the green color being larger than source-drain capacitance in a pixel for displaying a red color.

With these configurations, it becomes possible to provide a display panel and a display device, both of which can attain an improvement in overcoming gradation deviation while maintaining versatility, without the need of a dedicated driver IC for correcting a voltage applied to liquid crystal corresponding to each of pixels of respective colors.

### BRIEF DESCRIPTION OF THE DRAWINGS

FIG. 1 is a plan view of a pixel in a display device in accordance with an embodiment of the present invention.

FIG. 2 is a cross-sectional view taken along line B-A of the pixel illustrated in FIG. 1.

FIG. 3 is a cross-sectional view taken along line C-A in the pixel illustrated in FIG. 1.

FIG. 4 is a graph showing how light transmittance is changed in response to a voltage applied to liquid crystal in a liquid crystal display device in accordance with an embodiment of the present invention.

FIG. 5 is a block diagram of a liquid crystal display device and a liquid crystal display panel in accordance with an embodiment of the present invention.

FIG. 6 is a graph showing how a shift amount of chromaticity coordinates of white changes in response to fluctuation in thickness of pixels, as light transmittance changes.

FIG. 7 is a graph showing how light transmittance is changed in response to a voltage applied to liquid crystal in a conventional liquid crystal display device.

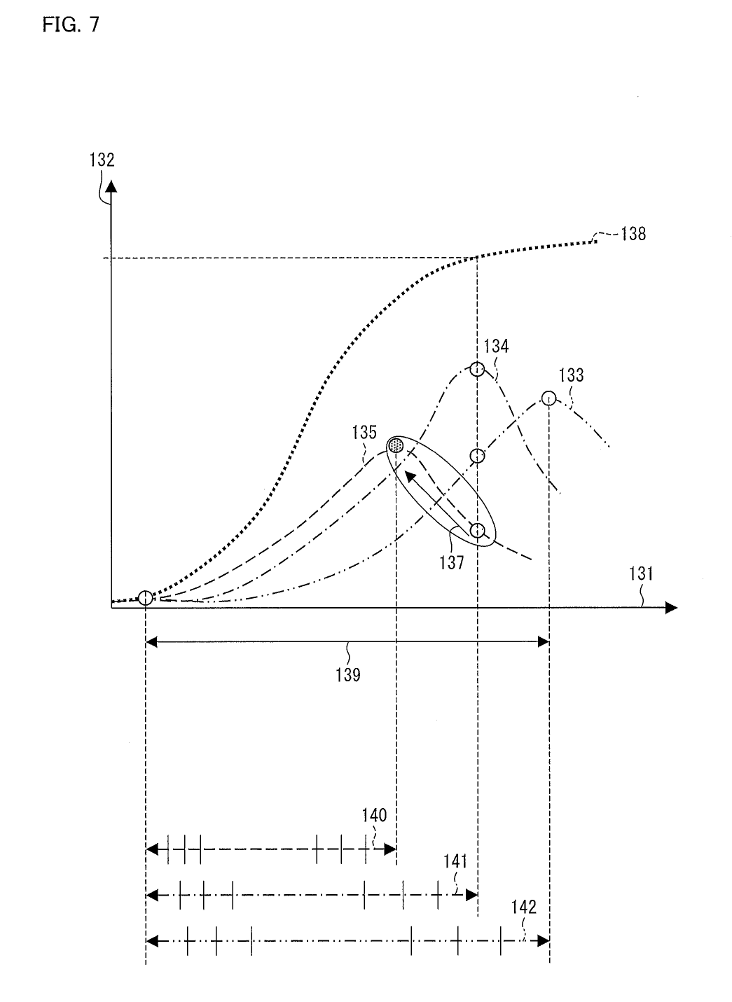

### DETAILED DESCRIPTION OF THE INVENTION

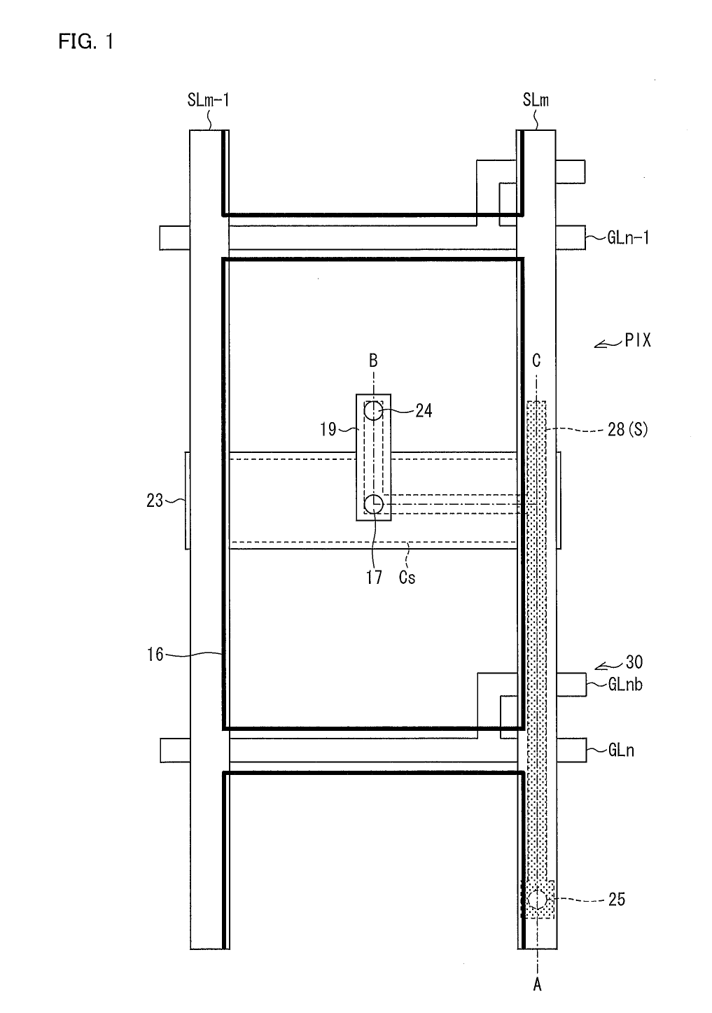

The following description will discuss an embodiment of the present invention with reference to FIGS. 1 through 5.

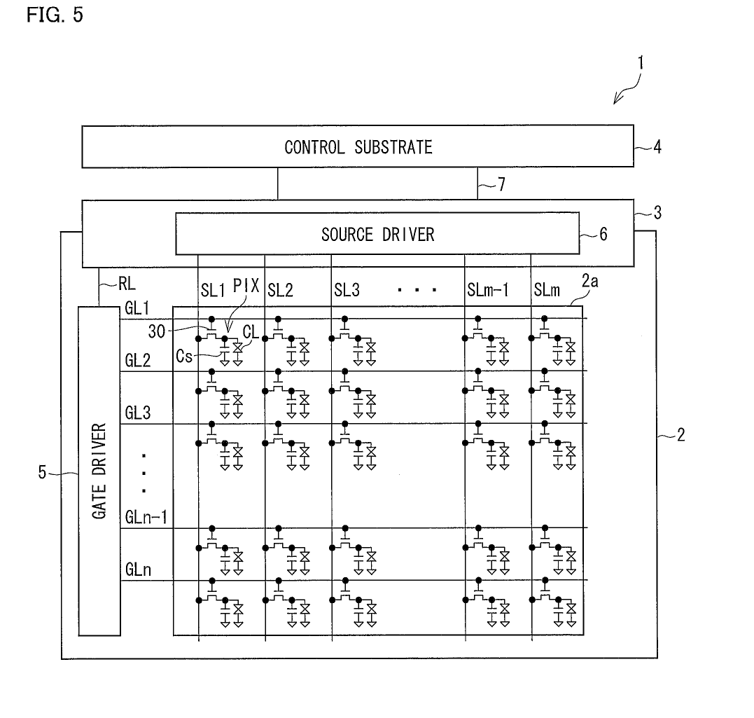

FIG. 5 is a view illustrating a schematic configuration of a display device 1 in accordance with an embodiment of the present invention. As illustrated in FIG. 5, the display device 1 includes a display panel 2, a flexible printed-circuit board 3, a control substrate 4, and flexible connecting wiring 7. The display panel 2 has a plurality of pixels each displaying a corresponding one of a plurality of types of colors. The plurality of pixels display respective different colors. The different colors are, for example, color additive primaries.

The display panel 2 is an active matrix display panel in which a display area 2a, a plurality of gate bus lines (scanning signal lines) GL, a plurality of source bus lines (data signal lines) SL, and a gate driver 5 are fabricated on a glass substrate by use of amorphous silicon. The material of the display panel 2 of the present embodiment is not limited to amorphous silicon. Examples of a material of the display panel 2 encompass polycrystal silicon, CG (Continuous Grain) silicon, and microcrystalline silicon.

The display area 2a is an area in which a plurality of pixels PIX are arranged in a matrix manner. Each of the plurality of pixels PIX includes (i) a TFT (Thin Film Transistor, switching element) 30, which is an element for selecting the each of the plurality of pixels PIX, (ii) a liquid crystal capacitor CL, and (iii) a storage capacitor Cs. The use of the TFT 30 as a switching element allows a reduction in thickness of the display panel 2.

A gate of the TFT 30 is connected with a corresponding one of the plurality of gate bus lines GL. A source of the TFT 30 is connected with a corresponding one of the plurality of source bus lines SL. A voltage is applied to the source of the TFT 30 in accordance with a data signal (later described). The liquid crystal capacitor CL and the storage capacitor Cs are connected with a drain of the TFT 30.

The plurality of gate bus lines GL are made up of a plurality of gate bus lines GL1, GL2, GL3, . . . , and GLn, which are connected with respective outputs of the gate driver 5. The plurality of source bus lines SL are made up of a plurality of source bus lines SL1, SL2, SL3, . . . , and SLm, which are connected with respective outputs of a source driver 6. The display panel 2 further includes storage capacitor wiring (not shown) for supplying storage capacitor voltages to respective storage capacitors Cs that retain electric charges of liquid crystal for the respective plurality of pixels PIX.

The gate driver 5 is provided on the display panel 2 in an area which is adjacent to the display area 2a on a side of one ends of the plurality of gate bus lines GL. The gate driver 5 supplies a gate pulse sequentially to corresponding one of the plurality of gate bus lines GL. The gate driver 5 is manufactured in the display panel 2 monolithically with the display area 2a, by use of amorphous silicon, polycrystal silicon, CG silicon, microcrystalline silicon, or the like. Gate drivers described with such terms as ‘gate monolithic,’ gate driver-less,' panel with a built-in gate driver,' and ‘gate-in-panel’ can all be encompassed in examples of the gate driver 5.

The flexible printed-circuit board 3 includes the source driver 6. The source driver 6 supplies data signals to the respective plurality of source bus lines SL. The control substrate 4 is connected with the flexible printed-circuit board 3 via the flexible connecting wiring 7 and supplies a necessary signal and electric power to the gate driver 5 and the source driver 6. The signal and the electric power to be supplied from the control substrate 4 to the gate driver 5 are supplied to the gate driver 5, via the flexible connecting wiring 7, the flexible printed-circuit board 3, and the wiring RL which is provided on the display panel 2, in this order.

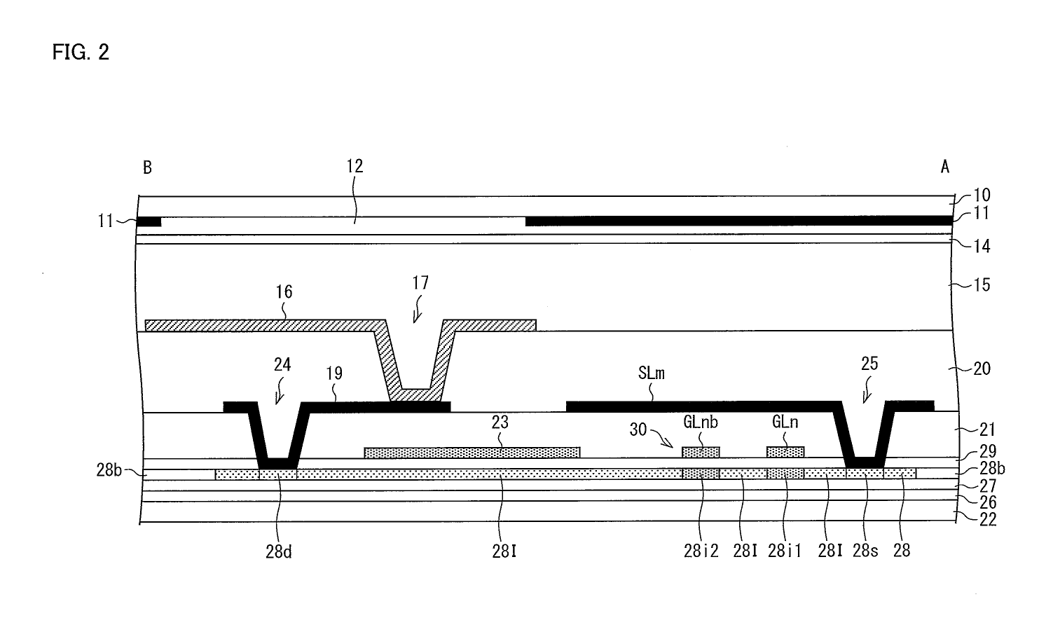

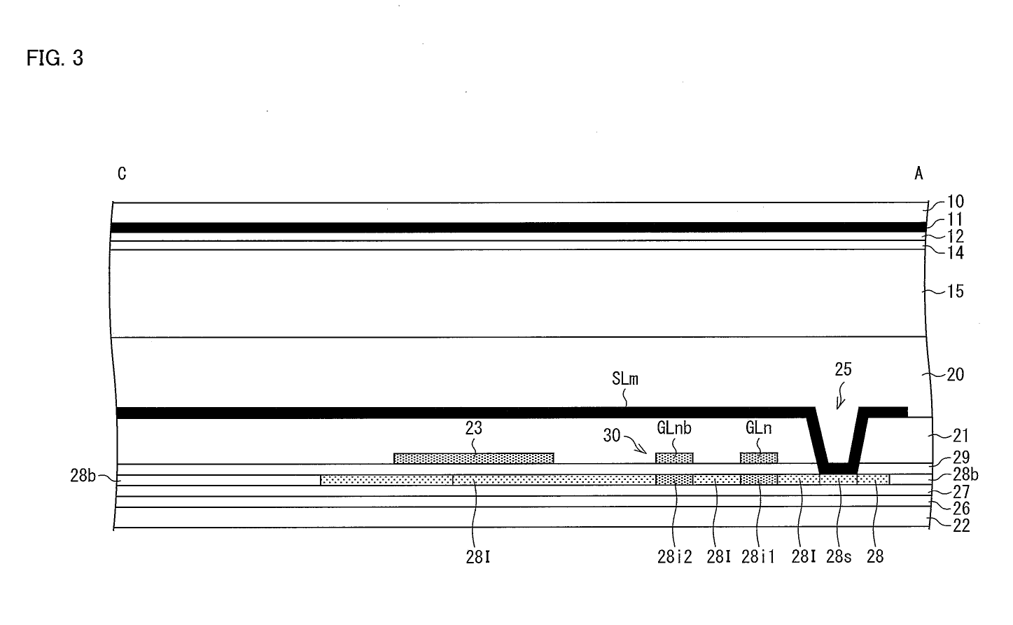

FIG. 1 is a plan view of one of the plurality of pixels PIX in the display device 1 illustrated in FIG. 5. FIG. 2 is a cross-sectional view taken along line B-A of the pixel PIX illustrated in FIG. 1. FIG. 3 is a cross-sectional view taken along line C-A of the pixel PIX illustrated in FIG. 1.

For visual simplicity, FIG. 1 omits members included in a color filter substrate (counter substrate) and only illustrates members included in a TFT substrate. As illustrated in FIG. 1, the TFTs 30 are provided near at intersections of the source bus lines SLm and the gate bus lines GLn. A pixel electrode 16 and storage capacitor wiring 23 are provided in a pixel area defined by the source bus lines (SLm-1 and SLm) and the gate bus lines (GLn-1 and GLn). The storage capacitor wiring 23 and the gate bus lines (GLn-1 and GLn) are provided in a same layer.

As illustrated in FIGS. 2 and 3, the display panel 2 includes a color filter substrate 10, a black matrix 11, a color filter 12, a common electrode 14, liquid crystal 15, the pixel electrode 16, a through hole 17, a drain electrode 19, a resin layer (transparent insulating film) 20, an inter-layer insulating film 21, a TFT substrate 22, the storage capacitor wiring 23, the gate bus line GLn, a gate electrode GLnb, the source bus line SLm, a drain contact 24, a source contact 25, base coats 26 and 27, a semiconductor layer 28, and a gate insulating film 29. The color filter 12 is, for example, any of a blue color filter, a green color filter, and a red color filter. The common electrode 14 and the pixel electrode 16 are made from ITO (Indium Tin Oxide). The capacitor of the liquid crystal 15 is the liquid crystal capacitor CL. The through hole 17 is formed in the resin layer 20 from the color filter 12 side. The base coats 26 and 27 are provided for attaining good electric properties of the TFT 30, which is configured by the semiconductor layer 28. The base coats 26 and 27 are made from Si oxide (SiO₂), for example.

Initially, the following description will discuss a configuration of the display panel 2 with reference to FIG. 2.

As illustrated in FIG. 2, the color filter substrate 10 and the TFT substrate 22 are arranged in the display panel 2 so that the liquid crystal 15 is interposed between the color filter substrate 10 and the TFT substrate 22. The black matrix 11 and the color filter 12 are provided on the color filter substrate 10. To prevent light from leaking out of an area between the color filter 12 and another color filter 12 adjacent to the color filter 12, the black matrix 11 is provided between the color filter 12 and the another color filter .12. The common electrode 14 is provided on the color filter 12 and the black matrix 11.

On the TFT substrate 22, there are provided the base coat 26, the base coat 27, the semiconductor layer 28, and the gate insulating film 29 in this order. The storage capacitor wiring 23, the gate bus line GLn, and the gate electrode GLnb are provided, within a same layer, on the gate insulating film 29. The inter-layer insulating film 21 covers the storage capacitor wiring 23, the gate bus line GLn, and the gate electrode GLnb. Since the storage capacitor wiring 23, the gate bus lines (GLn-1 and GLn), and the gate electrode GLnb are in the same layer, the thickness of the display panel 2 can be reduced. A base coat 28b is provided in an area which is on the base coat 27 and in which no semiconductor layer 28 is provided.

The source bus line SLm is provided on the inter-layer insulating film 21 and is connected with the semiconductor layer 28 via the source contact 25. Likewise, the drain electrode 19 is provided on the inter-layer insulating film 21 (i.e., in the same layer as the source bus line SLm) and is connected with the semiconductor layer 28 via the drain contact 24. The inter-layer insulating film 21 allows (i) the source bus line SLm and the drain electrode 19 to be electrically insulated from (ii) the storage capacitor wiring 23, the gate bus lines (GLn-1 and GLn), and the gate electrode GLnb.

The resin layer 20 is provided on the inter-layer insulating film 21. The pixel electrode 16 for the pixel which corresponds to the color filter 12 i s provided on the resin layer 20. The pixel electrode 16 is connected with the drain electrode 19 via the through hole 17.

The color filter substrate 10 and the TFT substrate 22 are each a glass substrate. The semiconductor layer 28 is made from silicon. The semiconductor layer 28 is an n+ layer doped with an impurity. However, in the semiconductor layer 28, (i) an area located below the gate bus line GLn is an i-layer 28i1 which is not doped with an impurity and (ii) an area located below the gate electrode GLnb is an i-layer (channel area) 28i2 which is not doped with impurities.

In the i-layer 28i2, a carrier is induced by the gate electrode GLnb, to which a gate pulse for causing the gate bus line GLn to be selected is applied. Like in the i-layer 28i2, a carrier is induced in the i-layer 28i1 by the gate bus line GLn, to which a gate pulse is applied.

In the semiconductor layer 28, (i) an area located below the drain contact 24 is an n+ layer (drain area) 28d and (ii) an area located below the source contact 25 is an n+ layer (source area) 28s.

In the semiconductor layer 28, (i) an area between the n+ layer 28d and the i-layer 28i2, (ii) an area between the i-layer 28i2 and the i-layer 28i1, and (iii) an area between the i-layer 28i1 and the n+ layer 28s are each an n+ layer (intermediate area) 28I. The provision of the n+ layers 28I allows an area of a part of the semiconductor layer 28 to be changed, which part is located below the source bus line SLm.

Since the semiconductor layer 28 includes the i-layers 28i1 and 28i2, the n+ layers 28d and 28s, and intermediate layers 28I, the TFT 30 can be constituted by the gate electrode GLnb, the gate insulating film 29, the semiconductor layer 28, the drain contact 24, and the source contact 25.

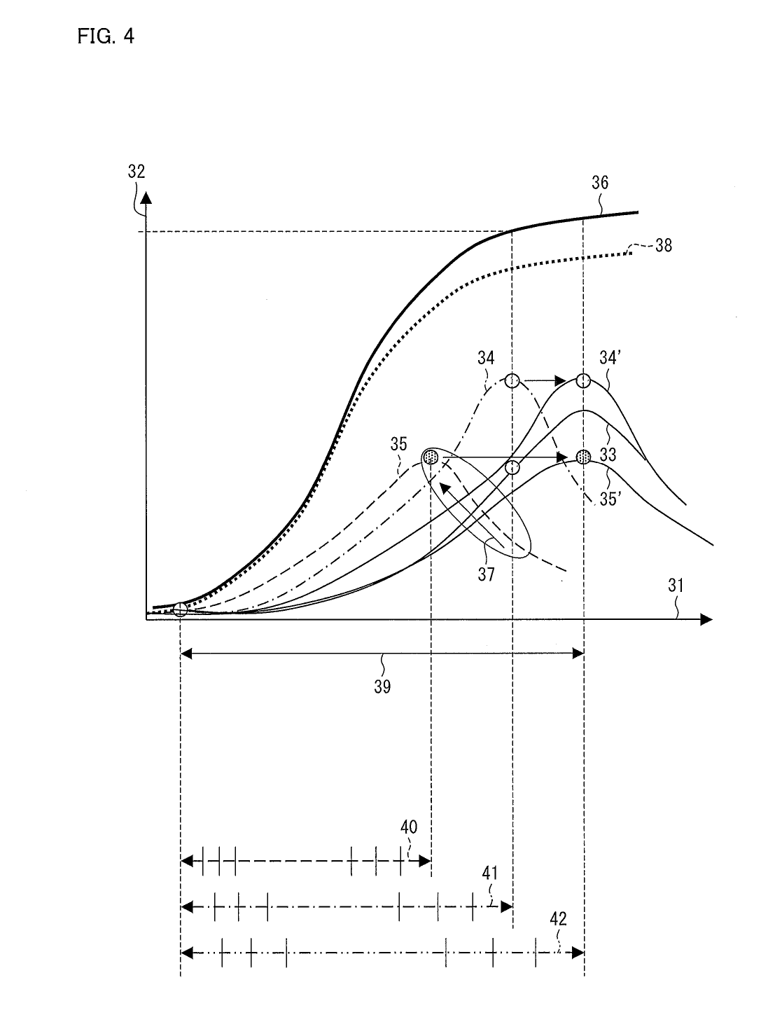

FIG. 4 is a graph showing how light transmittance 32 is changed in response to a voltage 31 applied to liquid crystal in the display device 1 in accordance with the embodiment of the present invention. Note that the voltage 31 is applied to the liquid crystal 15 between the pixel electrode 16 and the common electrode 14. Namely the voltage 31 is an electric potential of the pixel electrode 16.

The graph in FIG. 4 shows light transmittance 33 (hereinafter referred to as transmittance 33) of a pixel (hereinafter referred to as pixel R) corresponding to a red color filter, light transmittance 34 (hereinafter referred to as transmittance 34) of a pixel (hereinafter referred to as a pixel G) corresponding to a green color filter, and light transmittance 35 (hereinafter referred to as transmittance 135) of a pixel (hereinafter referred to as a pixel B) corresponding to a blue color filter.

The double-pointed arrow 39 directly below the graph in FIG. 4 indicates a range within which an effective voltage to be applied to liquid crystal is set in the source driver 6. The three double-pointed arrows indicated below the double-pointed arrow 39 are, from top, (i) a voltage 40 (effective voltage, hereinafter referred to as a voltage 40) applied to liquid crystal corresponding to the pixel B, (ii) a voltage 41 (hereinafter referred to as a voltage 41) applied to liquid crystal corresponding to the pixel G, and a voltage 42 (hereinafter referred to as a voltage 42) applied to liquid crystal corresponding to the pixel R. The voltage 40 is a voltage at which the transmittance 35 becomes a maximum value, and is lower than the voltage 41. The voltage 41 is a voltage at which the transmittance 34 becomes a maximum value, and is lower than the voltage 42. The voltage 42 is a voltage at which the transmittance 33 becomes a maximum value.

A sum (transmittance 38 of an achromatic color, which ranges from black to white) of the transmittances 33, 34, and 35 obtained in a case where a same voltage is applied to the liquid crystals corresponding to the respective pixels R, G, and B is indicated by the bold broken line. The arrow 37 indicates that the transmittance 35 is increased in a case where an applied voltage is changed from the voltage 41 to the voltage 40.

As shown by the transmittances 33, 34, and 35, a voltage at which light transmittance becomes a maximum value differs from color to color. In most cases, the voltage at which the light transmittance becomes the maximum value decreases in a descending order of red, green, and blue.

In each pixel in the display device 1, source-drain capacitance Csd (parasitic capacitance) is generated between the source bus line SLm and the drain electrode 19. According to the display device 1, in a case where a voltage of the source bus line SL fluctuates while the TFT 30 is in a off-state, the source-drain capacitance Csd causes an electric potential of the pixel to fluctuate. That is, a fluctuation in the voltage of the source bus line SL causes the electric potential of the pixel to be subjected to a feed-through voltage (a voltage drop). The larger the feed-through voltage, the lower the electric potential of the pixel (i.e., the voltage applied to liquid crystal corresponding to the pixel).

According to the display device 1, source-drain capacitance Csd is set to be larger in a pixel, corresponding to a color filter, in which a voltage at which light transmittance becomes a maximum value is lower. This causes a change in the feed-through voltage to which an electric potential of the pixel is subjected, depending on the color of a color filter to which the pixel corresponds. This allows a change in effective voltage applied to liquid crystal of the pixel corresponding to the color filter, depending on the color of the color filter to which the pixel corresponds. As a result, it becomes possible to obtain maximum transmittances for the respective colors of the color filters to which the respective pixels correspond.

For example, the voltage, at which the light transmittance of the pixel B becomes a maximum value, is lower than those of the pixels R and G. Because of this, the source-drain capacitance Csd in the pixel B is set to the largest of the pixels R, G, and B. This causes an impedance of the source-drain capacitance Csd in the pixel B to be the smallest of the pixels R, G, and B, so that the feed-through voltage, to which an electric potential of the pixel B is subjected, becomes the largest of the pixels R, G, and B. This allows the voltage applied to the liquid crystal corresponding to the pixel B to be lower than the voltages applied to the liquid crystals corresponding to the respective pixels R and G.

Note that a fluctuation in the voltage of the source bus line SL is caused by, for example, carrying out horizontal line reverse polarity driving, in which polarities of drive voltages in respective pixels are reversed every predetermined number of horizontal lines.

The capacitance Csd in the pixel B is set to the largest of the pixels R, G, and B so that a shift amount of the effective voltage for the pixel B becomes the largest of the pixels R, G, and B. In contrast, the capacitance Csd in the pixel R is set to the smallest of the pixels R, G, and B so that a shift amount of the effective voltage for the pixel R becomes the smallest of the pixels R, G, and B.

The electric potential of the pixel electrode 16, namely the voltage applied to the liquid crystal 15 between the pixel electrode 16 and the common electrode 14, decreases as the source-drain capacitance Csd in the semiconductor layer 28, which constitutes the TFT 30, is increased (see FIG. 2). The source-drain capacitance Csd increases as an area S of a part of the semiconductor layer 28 is increased, which part is located below the source bus line SLm. On the basis of this, source-drain capacitance Csd_{B} in the pixel B, source-drain capacitance Csd_{G} in the pixel G, and source-drain capacitance Csd_{R} in the pixel R are set so as to meet the following inequality (capacitance Csd_{R})<(capacitance Csd_{G})<(capacitance Csd_{B}).

It is possible to apply a voltage, at which the transmittance in each of the pixels R, G, and B becomes a maximum value, to the liquid crystals corresponding to the pixels R, G, and B, in a case where (i) the capacitances Csd_{R}, Csd_{G}, and Csd_{B} are set in the manner described and (ii) a voltage is equally applied to the source bus lines SLm corresponding to the pixels R, G, and B, which voltage is not lower than the highest voltage of the voltages at which the transmittances in the pixels R, G, and B become their respective maximum values. This makes it possible to prevent gradation deviation in the pixels B and G.

The transmittances 33 through 35 in FIG. 4 are graphs obtained in a case where the abscissa axis is the voltages 40 through 42 applied to the liquid crystals corresponding to the respective pixels R, G, and B. It is possible to obtain an effect of the transmittance 34 shifting toward a high electric potential side (right-hand side of the graph shown in FIG. 4), so as to be like transmittance 34′, in a case where (i) the abscissa axis is a voltage of the source bus line SLm and (ii) the voltage 42, which (a) is a voltage at which the transmittance in the pixel R becomes a maximum value and (b) is the highest of the voltages 40 through 42 at which the transmittances of the respective pixels R, G, and B become their respective maximum values, is applied to the source bus line SLm corresponding to the pixel G. Likewise, it is possible to obtain an effect of the transmittance 35 shifting toward the high electric potential side, so as to be like transmittance 35′, in a case where (i) the abscissa axis is a voltage of the source bus line SL and (ii) the voltage 42 is applied, in a similar manner, to the source bus line SLm corresponding to the pixel B.

The shifting of the transmittances makes it possible to obtain a sum of the transmittances 33, 34′, and 35′ (transmittance 36 of white) as indicated by the bold line in the graph shown in FIG. 4. This allows an improvement in the transmittance 36 of white, which is overall transmittance of the pixels R, G, and B, as compared with the transmittance 38 of white which has not been subjected to the shifting of the transmittances.

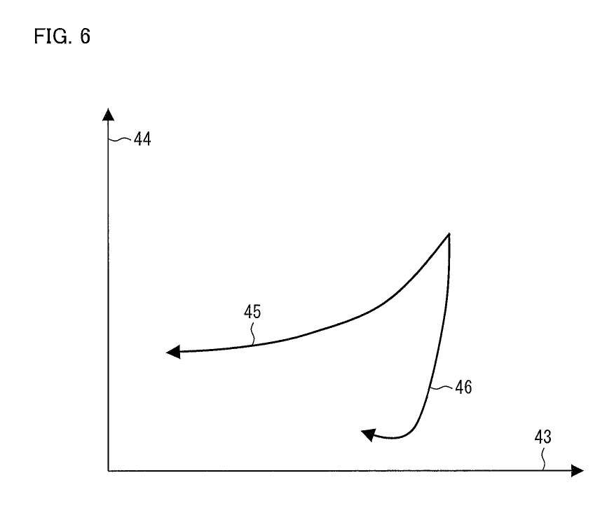

The following description will additionally discuss, with reference to FIG. 6, how the display panel 2 controls color unevenness caused by nonuniformity of thickness among the pixels R, G, and B.

FIG. 6 is a graph showing how a shift amount 44 of chromaticity coordinates of white changes in response to fluctuation in thickness of the pixel R, G, and B, as light transmittance 43 changes in the pixels R, G, and B having a predetermined thickness. The shift amount 44 of chromaticity coordinates of white can be found by {(x1-x2)²+(y1-y2)²}^{1/2} where (i) (x1, y1) are chromaticity coordinates of white display obtained in a case where the thickness of the pixel is {[predetermined thickness]+0.1 μm} and (ii) (x2, y2) are chromaticity coordinates of white display obtained in a case where the thickness of the pixel is {[predetermined thickness]−0.1 μm}.

The light transmittance 43 and the shift amount 44 of chromaticity coordinates of white are each calculated based on a simulation. A shift amount 45 of chromaticity coordinates of white is a trajectory of points of intersection between the light transmittance and the shift amount of chromaticity coordinates of white, which trajectory is obtained in a case where voltages applied to the respective pixels R, G, and B are lowered at the same time. The shift amount 45 of chromaticity coordinates of white is indicated by a bold arrow in the graph shown in FIG. 6.

A shift amount 46 of chromaticity coordinates of white is a trajectory of points of intersection between the light transmittance and the shift amount of chromaticity coordinates of white, which trajectory is obtained in a case where (i) the voltage applied to the pixel R and the voltage applied to the pixel G are unchanged (maintained at high voltages) and (ii) the voltage applied to the pixel B is lowered. The shift amount 46 of chromaticity coordinates of white is indicated by a bold arrow in the graph shown in FIG. 6.

In the arrow of the shift amount 45 of chromaticity coordinates of white, the voltage applied has (i) a maximum value at the initial point of the arrow and (ii) a minimum value at the final point (tip) of the arrow. Likewise, in the arrow of the shift amount 46 of chromaticity coordinates of white, the voltage applied has (i) a maximum value at the initial point of the arrow and (ii) a minimum value at the final point of the arrow.

According to the display panel 2, the shift amount 45 of chromaticity coordinates of white and the shift amount 46 of chromaticity coordinates of white show that it is possible to (i) control the shift amount of chromaticity coordinates of white (i.e., color unevenness of white caused by nonuniformity of thickness of the pixels R, G, and B) and (ii) prevent a decrease in transmittance, more successfully in a case where a low voltage is applied only to the pixel B as compared with a case where a same voltage is applied to all of the pixels R, G, and B (see FIG. 6).

As described above, according to the display device 1 in accordance with an embodiment of the present invention, source-drain capacitance Csd is set to be larger in a pixel, corresponding to a color filter, in which a voltage at which light transmittance becomes a maximum value is lower. This setting causes an effective value of the voltage, applied to the liquid crystal corresponding to the pixel, to be reduced. This makes it possible to apply a voltage, at which light transmittance in a pixel corresponding to a color filter becomes a maximum value, to liquid crystal 15 corresponding to the pixel, even in a case where the voltage at which the light transmittance in the pixel becomes a maximum voltage is low. Accordingly, it becomes possible to (i) prevent gradation deviation in the pixels R, G, and B and (ii) improve the overall transmittance of the pixels (the pixels R, G, and B included in the display panel 2), in other words, transmittance of white light.

Therefore, it becomes possible to attain the same effect as that attained by the RGB independent γ-setting, by correcting voltages to be applied to liquid crystals corresponding to respective pixels R, G, and B, instead of using a driver IC dedicated for the RGB independent γ-setting, in which a γ characteristic is set separately for each of the pixels R, G, and B.

In the display device 1, since the area S of the part of the semiconductor layer 28, which part is below the source bus line SLm, is changed depending on the color to be displayed by the pixel, decrease in aperture ratio can be prevented. This facilitates control in a process. Further, unlike the invention disclosed in Patent Literature 2, the value of the storage capacitor is not changed among the pixels of the respective colors, so that charge retention characteristic is equivalent among the colors. This makes it possible to prevent display unevenness or flickers, both caused by differences in charge retention characteristic. Since it is only necessary that the source-drain capacitance of the TFT 30 be set in accordance with the color displayed by each of the pixels, it is not necessary to use capacity coupling driving method, which is a driving method in which (i) a compensating voltage pulse is applied to the storage capacitor wiring 23 (Cs wiring) so as to cause a sharp increase or decrease in electric potential by means of capacity coupling and (ii) the sharp increase or decrease is utilized so as to cause a change in the electric potential of the pixel electrode.

In the display panel 2, the semiconductor layer 28 located below the source bus line SLm can extend below the source bus line SLm so as to be adjacent to both (i) a first pixel with which the TFT 30 is connected and (ii) a second pixel, adjacent to the first pixel, which is provided so that the gate bus line GLn is sandwiched between the first pixel and the second pixel.

Since the semiconductor layer 28 thus extends below the source bus line SLm, it becomes easier to (i) change the area of the semiconductor layer 28. It follows that the source-drain capacitance Csd can be more easily changed.

In the display panel 2, the TFT 30 can include the semiconductor layer 28, which includes (i) the n+ layer 28s connected with the source bus line SL (SL1, SL2, SL3, . . . , and SLm), through which data to be displayed on the pixel PIX is outputted, (ii) the n+ layer 28d connected with the drain electrode 19 which is connected with the pixel electrode 16 via which a voltage is applied to liquid crystal corresponding to the pixel PIX, and (iii) the i-layer 28i2 in which a carrier is induced by the gate electrode GLnb via which a gate pulse for causing the gate bus line GL (GL1, GL2, GL3, . . . , and GLn) to be selected is applied. An area of the semiconductor layer 28 located below the source bus line SL (SL1, SL2, SL3, . . . , and SLm) can vary depending on the color displayed the pixel PIX.

Since the semiconductor layer 28 located below the source bus line SL (SL1, SL2, SL3, . . . , and SLm) varies depending on the color displayed the pixel PIX, it becomes possible to cause the capacitance between the source of the TFT 30 and the drain of the TFT 30 in the PIX to vary depending on the color displayed by the pixel PIX.

In addition, since the area of the semiconductor layer 28 located below the source bus line SL (SL1, SL2, SL3, . . . , and SLm) is caused to vary depending on the color displayed by the pixel PIX, (i) decrease in aperture ratio can be prevented and (ii) an area of the semiconductor layer 28 can be easily controlled in the manufacturing process.

Further, since changing the voltage at which the light transmittance becomes a maximum value does not require changing of the value of the storage capacitor Cs, which value is set for each of the plurality of pixels PIX in accordance with the color of the pixel, charge retention characteristics obtained in the plurality of pixels PIX of the respective colors are substantially equal. This makes it possible to prevent display unevenness or flickers, both caused by differences in charge retention characteristic.

Since it is only necessary that the drain-source capacitance of the TFT 30 in the pixel PIX vary depending on the color displayed by the pixel PIX, it is not necessary to use capacity coupling driving method, which is a driving method in which (i) a compensating voltage pulse is applied to the storage capacitor wiring 23 (Cs wiring) so as to cause a sharp increase or decrease in an electric potential by means of capacity coupling and (ii) the sharp increase or decrease is utilized so as to cause the electric potential of the pixel electrode 16 to change.

In the display panel 2, source-drain capacitance in a pixel PIX for displaying a green color can be larger than source-drain capacitance in a pixel PIX for displaying a red color, and source-drain capacitance in a pixel PIX for displaying a blue color can be larger than the source-drain capacitance in the pixel PIX for displaying the green color.

The voltage at which the light transmittance of the pixel PIX for displaying the red color is higher than the pixel PIX for displaying the green color, and the pixel PIX for displaying the green color is higher than the pixel PIX for displaying the blue. As such, the source-drain capacitance is set to be larger in a pixel PIX, corresponding to a color filter, in which a voltage at which light transmittance becomes a maximum value is lower. This allows the effective voltage for the pixel to be reduced.

Specifically, in the pixel PIX for displaying the blue color, the source-drain capacitance is set to the largest of the pixels for displaying the respective colors. This allows the effective voltage for the pixel PIX for displaying the blue color to be the lowest of the pixels for displaying the respective colors. In contrast, in the pixel for displaying the red color, the source-drain capacitance is set to the smallest of the pixels for displaying the respective colors. This allows the effective voltage for the pixel PIX for displaying the red color to be the highest of the pixels for displaying the respective colors.

In this manner, it becomes possible to apply, to liquid crystal corresponding to each of the plurality of pixels PIX for displaying the respective colors, a voltage at which transmittance of the color displayed by the pixel PIX becomes a maximum value, even in a case where the voltage applied to the source of the TFT 30 is equal among the pixels of the respective colors. Accordingly, it becomes possible to (i) prevent gradation deviation in the pixel PIX for displaying the blue color and in the pixel PIX for displaying the green color and (ii) improve overall transmittance of the pixels PIX (the pixels PIX of the respective colors included in the display panel 2), in other words, transmittance of white light.

In the display panel 2, the semiconductor layer 28 located below the source bus line SL (SL1, SL2, SL3, . . . , and SLm) can extend below the source bus line SL (SL1, SL2, SL3, . . . , and SLm) so as to be adjacent to both (i) a first pixel PIX with which the TFT 30 is connected and (ii) a second pixel PIX, adjacent to the first pixel PIX, which is provided so that the gate bus line GL (GL1, GL2, GL3, . . . , and GLn) is sandwiched between the first pixel PIX and the second pixel PIX.

Since the semiconductor layer 28 extends below the source bus line SL (SL1, SL2, SL3, . . . , and SLm), it becomes easier to (i) change the area of the semiconductor layer 28s and (ii) accordingly change the capacitance.

In the display panel 2, the semiconductor layer 28 can further include the n+ layer 28I between the n+ layer 28s and the i-layer 28i2 or between the n+ layer 28d and the i-layer 28i2.

Since the semiconductor layer 28 includes the n+ layer 28I, the area of the semiconductor layer 28 below the source bus line SL (SL1, SL2, SL3, . . . , and SLm) can be easily changed.

In the display panel 2, (i) the n+ layer 28s, the n+ layer 28d, and the n+ layer 28I can contain semiconductor which is doped with an impurity and (ii) the i-layer 28i2 can contain semiconductor which is not doped with an impurity.

This allows the TFT 30 to be constituted by the semiconductor layer 28.

In the display panel 2, (i) the storage capacitor wiring 23, via which a storage capacitor voltage is supplied to the storage capacitor Cs for retaining an electric charge of the liquid crystal 15, (ii) the gate bus line GL (GL1, GL2, GL3, . . . , and GLn), and (iii) the gate electrode GLnb can be provided in the same layer.

This makes it possible to reduce the thickness of the display panel 2.

In the display panel 2, the source bus line SL (SL1, SL2, SL3, . . . , and SLm) and the drain electrode 19 can be provided in the same layer, and the inter-layer insulating film 21 is provided between (i) the source bus line SL (SL1, SL2, SL3, . . . , and SLm) and the drain electrode 19 and (ii) the storage capacitor wiring 23, the gate bus line GL (GL1, GL2, GL3, . . . , and GLn), and the gate electrode GLnb.

This allows (a) the source bus line SL (SL1, SL2, SL3, . . . , and SLm) and the drain electrode 19 to be electrically insulated from (b) the storage capacitor wiring 23, the gate bus line GL (GL1, GL2, GL3, . . . , and GLn), and the gate electrode GLnb.

In the display panel 2, the switching element can be the TFT 30.

This makes it possible to reduce the thickness of the display panel 2.

The display device 1 in accordance with the present embodiment includes the display panel 2 and therefore makes it possible to attain an improvement in overcoming gradation deviation while maintaining versatility, without the need of a dedicated driver IC for correcting the voltage 31 applied to the liquid crystal corresponding to each of the pixels PIX of the respective colors.

The present invention is not limited to the above-described embodiments but allows various modifications within the scope of the claims. Any embodiment obtained by appropriately combining the technical means disclosed in the different embodiments will also be included in the technical scope of the present invention.

The display panel of the present invention can attain an improvement in overcoming gradation deviation while maintaining versatility, without the need of a dedicated driver IC for correcting a voltage applied to liquid crystal corresponding to each of pixels of respective colors. Therefore, the display panel of the present invention can be suitably applied to a liquid crystal display panel for color display of an image.

### REFERENCE SIGNS LIST

1: display device
2: display panel
2a: display area
3: flexible printed-circuit board
4: control substrate
5: gate driver
6: source driver
7: flexible connecting wiring
10: color filter substrate
11: black matrix
12: color filter
14: common electrode
15: liquid crystal
16: pixel electrode
17: through hole
19: drain electrode
20: resin layer
21: inter-layer insulating film
22: TFT substrate
23: storage capacitor wiring
24: drain contact
25: source contact
26, 27, and 28b: base coat
28: semiconductor layer
28s: n+ layer (source area)
28d: n+ layer (drain area)
28i1: i-layer
28i2: i-layer (channel area)
28I: n+ layer (intermediate area)
29: gate insulating film
30: TFT (switching element, thin-film transistor)
31: voltage applied to liquid crystal
32 to 35, 34′, 35′, 36, 38: transmittance
37: arrow
39: double-pointed arrow
40 to 42: voltage
CL: liquid crystal capacitor
Cs: storage capacitor
Csd, Csd_{B}, Csd_{G}, and Csd_{R}: source-drain capacitor
GL (GL1, GL2, GL3, . . . , and GLn): gate bus line (scanning signal line)
GLnb: gate electrode
PIX: pixel
S: area
SL (SL1, SL2, SL3, . . . , and SLm): source bus line (data signal line)

1. A display panel comprising:
a plurality of pixels each (i) displaying a corresponding one of a plurality of colors and (ii) including a switching element,
a voltage being applied to liquid crystal which corresponds to each of the plurality of pixels so that the voltage is supplied to a source of the switching element and is outputted from a drain of the switching element,
a voltage at which light transmittance becomes a maximum value in the each of the plurality of pixels varying depending on the color displayed by the each of the plurality of pixels, source-drain capacitance between the source and the drain being set to be larger in a pixel for displaying a corresponding color, in which pixel a voltage at which light transmittance becomes a maximum value is lower.

2. A display panel comprising a plurality of pixels each including a corresponding different color filter and a switching element,
source-drain capacitance between a source and a drain of the switching element in each of the plurality of pixels being set so as to vary in accordance with a color displayed by the each of the plurality of pixels,
source-drain capacitance in a pixel for displaying a blue color being larger than source-drain capacitance in a pixel for displaying a green color, and the source-drain capacitance in the pixel for displaying the green color being larger than source-drain capacitance in a pixel for displaying a red color.

3. The display panel according to claim 1, wherein the switching element includes a semiconductor layer,
the semiconductor layer including (i) a source area connected with a data signal line from which data to be displayed on the each of the plurality of pixels is outputted, (ii) a drain area connected with a drain electrode which is connected with a pixel electrode via which a voltage is applied to liquid crystal corresponding to the each of the plurality of pixels, and (iii) a channel area in which a carrier is induced by a gate electrode via which a gate pulse for causing a scanning signal line to be selected is applied,
an area of the semiconductor layer located below the data signal line varies depending on the color displayed by the each of the plurality of pixels.

4. The display panel according to claim 1, wherein source-drain capacitance in a pixel for displaying a green color is larger than source-drain capacitance in a pixel for displaying a red color, and source-drain capacitance in a pixel for displaying a blue color is larger than the source-drain capacitance in the pixel for displaying the green color.

5. The display panel according to claim 3, wherein the semiconductor layer located below the data signal line extends below the data signal line so as to be adjacent to both (i) a first pixel with which the switching element is connected and (ii) a second pixel, adjacent to the first pixel, which is provided so that the scanning signal line is sandwiched between the first pixel and the second pixel.

6. The display panel according to claim 3, wherein the semiconductor layer further includes an intermediate area between the source area and the channel area or between the drain area and the channel area.

7. The display panel according to claim 6, wherein:
(i) each of the source area, the drain area, and the intermediate area contains semiconductor which is doped with an impurity and (ii) the channel area contains semiconductor which is not doped with an impurity.

8. The display panel according to claim 3, wherein (i) storage capacitor wiring, via which a storage capacitor voltage is supplied to a storage capacitor for retaining an electric charge of the liquid crystal, (ii) the scanning signal line, and (iii) the gate electrode are provided in a same layer.

9. The display panel according to claim 8, wherein:
the data signal line and the drain electrode are provided in a same layer, and
an inter-layer insulating film is provided between (i) the data signal line and the drain electrode and (ii) the storage capacitor wiring, the scanning signal line, and the gate electrode.

10. The display panel according to claim 1, wherein the switching element is a thin-film transistor.

11. A display device comprising a display panel recited in claim 1.

12. The display panel according to claim 2, wherein the switching element includes a semiconductor layer,
the semiconductor layer including (i) a source area connected with a data signal line from which data to be displayed on the each of the plurality of pixels is outputted, (ii) a drain area connected with a drain electrode which is connected with a pixel electrode via which a voltage is applied to liquid crystal corresponding to the each of the plurality of pixels, and (iii) a channel area in which a carrier is induced by a gate electrode via which a gate pulse for causing a scanning signal line to be selected is applied,
an area of the semiconductor layer located below the data signal line varies depending on the color displayed by the each of the plurality of pixels.

13. The display panel according to claim 12, wherein the semiconductor layer located below the data signal line extends below the data signal line so as to be adjacent to both (i) a first pixel with which the switching element is connected and (ii) a second pixel, adjacent to the first pixel, which is provided so that the scanning signal line is sandwiched between the first pixel and the second pixel.

14. The display panel according to claim 12, wherein the semiconductor layer further includes an intermediate area between the source area and the channel area or between the drain area and the channel area.

15. The display panel according to claim 14, wherein:
(i) each of the source area, the drain area, and the intermediate area contains semiconductor which is doped with an impurity and (ii) the channel area contains semiconductor which is not doped with an impurity.

16. The display panel according to claim 12, wherein (i) storage capacitor wiring, via which a storage capacitor voltage is supplied to a storage capacitor for retaining an electric charge of the liquid crystal, (ii) the scanning signal line, and (iii) the gate electrode are provided in a same layer.

17. The display panel according to claim 16, wherein:
the data signal line and the drain electrode are provided in a same layer, and
an inter-layer insulating film is provided between (i) the data signal line and the drain electrode and (ii) the storage capacitor wiring, the scanning signal line, and the gate electrode.

18. The display panel according to claim 2, wherein the switching element is a thin-film transistor.

19. A display device comprising a display panel recited in claim 2.
